(19) United States
(12) Patent Application Publication
(10) Pub. No.: US 2021/0012686 A1
(43) Pub. Date: Jan. 14, 2021

(54) Information Delivery Method and Information Delivery System Capable of Generating a Template for Displaying Information of Products

(71) Applicant: QISDA CORPORATION, Taoyuan City (TW)

(72) Inventors: Wei-Min Chiu, Taoyuan City (TW); Cheng-Te Tseng, Taoyuan City (TW)

(21) Appl. No.: 16/920,758

(22) Filed: Jul. 6, 2020

(30) Foreign Application Priority Data
Jul. 10, 2019 (CN) 201910618767.3

(51) Int. Cl. G09F 3/20; G09F 3/02; G06Q 30/02; G06T 7/13; G06Q 10/08

(52) U.S. Cl. CPC G09F 3/208; G09F 3/204; G09F 3/02; G09F 2003/0255; G06Q 30/0201; G06T 7/13; G06Q 10/087; G06Q 30/0268

(57) ABSTRACT

An information delivery method includes acquiring an image including a shelf laminate and a plurality of products placed on the shelf laminate by an image capturing device, selecting a template from a plurality of templates for displaying on a display placed on the shelf laminate according to image information of the plurality of products, and displaying at least one selling message of each product of the plurality of products on a display region of the display according to the template. The template displayed on the display includes a plurality of display regions. Each display region of the plurality of display regions is consistent with an allocated width and an allocated position of a corresponding product.

### BACKGROUND OF THE INVENTION

### 1. Field of the Invention

The present invention discloses an information delivery method and an information delivery system, and more particularly, an information delivery method and an information delivery system capable of generating a template for displaying information of products placed on a shelf laminate.

### 2. Description of the Prior Art

With rapid developments of technologies, purchasing various products and logistics services are more and more convenient for consumers. Many convenience stores, shopping malls, or grocery stores have a plurality of shelves. Each shelf contains at least one laminate for placing various products. In order to display names and selling prices of products for the consumers, traditional shelves use a manual method for placing at least one notepaper near corresponding products. The notepapers can list sales information, product information, special information, and discount periods. When a user wants to buy a product, the user has to look for the notepapers having sales messages before the user decides if he/she really needs to purchase this product.

However, when some products on the shelf laminate are picked up or removed by the users, the products placed on the shelf laminate may be messy. Further, the notepapers having sales messages may be dropped or shifted. Messy products and shifted notepapers can be rearranged after a service staff patrols the shelf laminate for noticing these products and notepapers. Therefore, before the messy products and shifted notepapers are rearranged by the service staff, they often cause inconvenience for consumers.

Moreover, in a traditional inventory management technology, merchants often use points of sale (POS) systems for acquiring a sales status and an inventory amount of the products placed on the shelf laminate. However, since the POS systems require checkout record information for analyzing the sales status and detecting the inventory amount of the products, it is impossible to acquire instant quantity statistics and perform sales status analysis for specific products placed on a single shelf laminate. In other words, an inventory management person cannot acquire the sales status of the specific products placed on the single shelf laminate in real-time. Therefore, when certain products are unsalable or out of stock, they cannot be processed in real-time, resulting in a low user's consumption experience.

### SUMMARY OF THE INVENTION

In an embodiment of the present invention, an information delivery method is disclosed. The information delivery method comprises acquiring an image comprising a shelf laminate and a plurality of products placed on the shelf laminate by an image capturing device, selecting a template from a plurality of templates for displaying on a display placed on the shelf laminate according to image information of the plurality of products, and displaying at least one selling message of each product of the plurality of products on a display region of the display according to the template. The template displayed on the display comprises a plurality of display regions. Each display region of the plurality of display regions is consistent with an allocated width and an allocated position of a corresponding product.

In an embodiment of the present invention, an information delivery system is disclosed. The information delivery system comprises a shelf laminate, an image capturing device, a display, a plurality of sensors, and a smart shelf processing device. The shelf laminate is configured to place a plurality of products. The image capturing device is configured to acquire an image comprising the shelf laminate and the plurality of products placed on the shelf laminate. The display is adjacent to the shelf laminate is configured to display sales information. The plurality of sensors are placed on the shelf laminate and configured to detect a sales status of the plurality of products. The smart shelf processing device is coupled to the plurality of sensors, the image capturing device, and the display. The smart shelf processing device selects a template from a plurality of templates for displaying on the display according to image information of the plurality of products. The display displays at least one selling message of each product of the plurality of products on a display region of the display according to the template. The template displayed on the display comprises a plurality of display regions. Each display region of the plurality of display regions is consistent with an allocated width and an allocated position of a corresponding product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an information delivery system according to an embodiment of the present invention.

FIG. 2 is an illustration of data flows of the information delivery system in FIG. 1.

FIG. 3A is an illustration of displaying first multimedia contents by a display of the information delivery system in FIG. 1.

FIG. 3B is an illustration of displaying second multimedia contents by the display of the information delivery system in FIG. 1.

FIG. 3C is an illustration of displaying third multimedia contents by the display of the information delivery system in FIG. 1.

FIG. 4 is a flow chart of performing an information delivery method by the information delivery system in FIG. 1.

### DETAILED DESCRIPTION

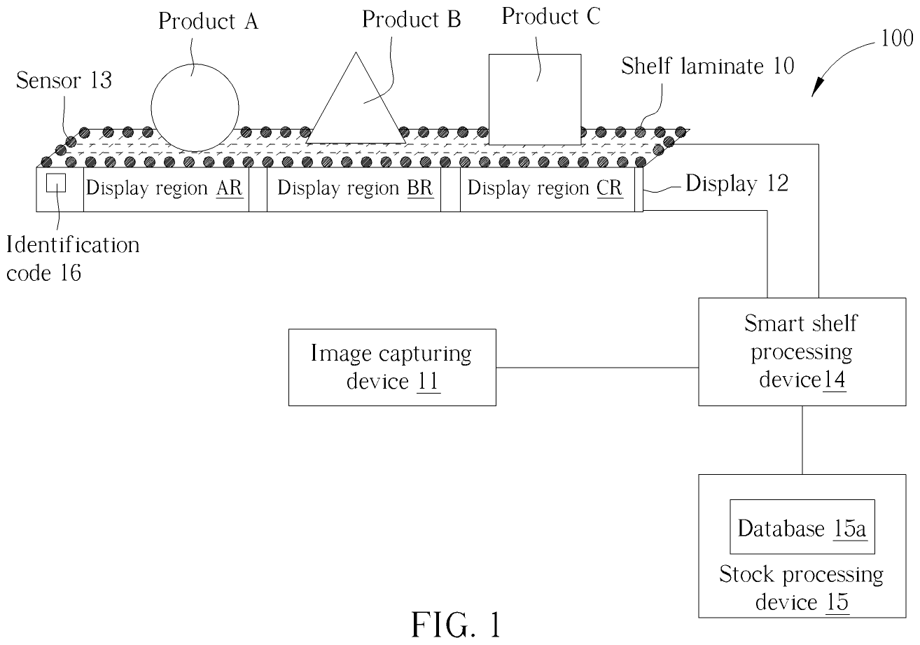

FIG. 1 is a block diagram of an information delivery system 100 according to an embodiment of the present invention. The information delivery system 100 includes a shelf laminate 10, an image capturing device 11, a display 12, a plurality of sensors 13, a smart shelf processing device 14, and a stock processing device 15. The shelf laminate 10 is used for placing a plurality of products A to C. Positions, sizes, and amount of the products placed on the shelf laminate 10 are not limited in the information delivery system 100. Alternatively, P products having a same type (i.e., same as the product A), Q products having a same type (i.e., same as the product B), and R products having a same type (i.e., same as the product C) can be placed on the shelf laminate 10. Here, P, Q, and R are positive integers. The image capturing device 11 is used for acquiring an image including the shelf laminate 10 and the plurality of products A to C placed on the shelf laminate 10. For example, the image capturing device 11 can be a camera. The camera can take a picture of an entire shelf, or take a picture of a part of the shelf laminate 10 for acquiring image data. The display 12 is adjacent to the shelf laminate 10 for displaying sales information. The display 12 can be any type of display devices, such as a liquid crystal display, a light-emitting diode display, or an electronic paper display. The plurality of sensors 13 are placed on the shelf laminate 10 for detecting a sales status of the plurality of products A to C according to the existence of the products A to C. A plurality of sensors 13 can be a plurality of optical sensors, such as infrared sensors or ultrasonic sensors. The plurality of sensors 13 can be placed around an edge of the shelf laminate 10, as shown in FIG. 1. The plurality of sensors 13 can also be placed along with an X-axis and a Y-axis of a surface of the shelf laminate 10. The plurality of sensors 13 can also be placed along with the X-axis, the Y-axis, and a Z-axis of a space of the shelf laminate 10. Any reasonable allocation of the sensors 13 falls into the scope of the present invention. Since the sensors 13 can be optical sensors, when some products are displaced or removed, the sensors 13 can directly detect quantity changes or position changes of these products. For example, the sensors 13 surrounding the edge of the shelf laminate 10 can detect all products placed on the plane of the shelf laminate 10. When some products are removed, the sensors 13 placed along with the X-axis and Y-axis corresponding to these products can detect the disappearance of these products. In practice, the plurality of sensors 13 can periodically detect an amount of the products A to C placed on the shelf laminate 10 for periodically updating the sales status of the products A to C. The smart shelf processing device 14 is coupled to the plurality of sensors 13, the image capturing device 11, and the display 12. The smart shelf processing device 14 can be a server or at least one computer for managing the sales status data and sales history data of the products, and generating an appropriate template to display at least one selling message by the display 12. The stock processing device 15 is coupled to the smart shelf processing device 14. The stock processing device 15 includes a database 15a for saving inventory data of the products, price data of the products, product type data, and marketing strategy data of the products. The stock processing device 15 can be a server controlled by a third-party manufacturer.

In the information delivery system 100, the smart shelf processing device 14 can select a template from a plurality of templates for displaying on the display 12 according to image information of the plurality of products A to C. The template displayed on the display 12 includes a plurality of display regions AR to CR. Each display region of the plurality of display regions AR to CR is consistent with an allocated width and an allocated position of a corresponding product. For example, a width of the display region AR is determined by an allocated width of the product A. A position of the display region AR is determined by an allocated position of the product A. A width of the display region BR is determined by an allocated width of the product B. A position of the display region BR is determined by an allocated position of the product B. A width of the display region CR is determined by an allocated width of the product C. A position of the display region CR is determined by an allocated position of the product C. However, widths of the display region AR, the display region BR, and the display region CR can be appropriately adjusted. For example, the widths of the display region AR, the display region BR, and the display region CR can be scaled in proportion to the widths of the product A, the product B, and the product C. Further, two adjacent display regions can introduce a gap or can be close to each other. Any technology modification falls into the scope of the present invention. The smart shelf processing device 14 can control the display 12 for displaying at least one selling message (i.e., such as a product name message and/or a product price message) of each product of the plurality of products on the display region according to the template. For example, at least one selling message of the product A can be posted to the display region AR. At least one selling message of the product B can be posted to the display region BR. At least one selling message of the product C can be posted to the display region CR. Details of how to generate the template and at least one selling message by the information delivery system 100 are illustrated later.

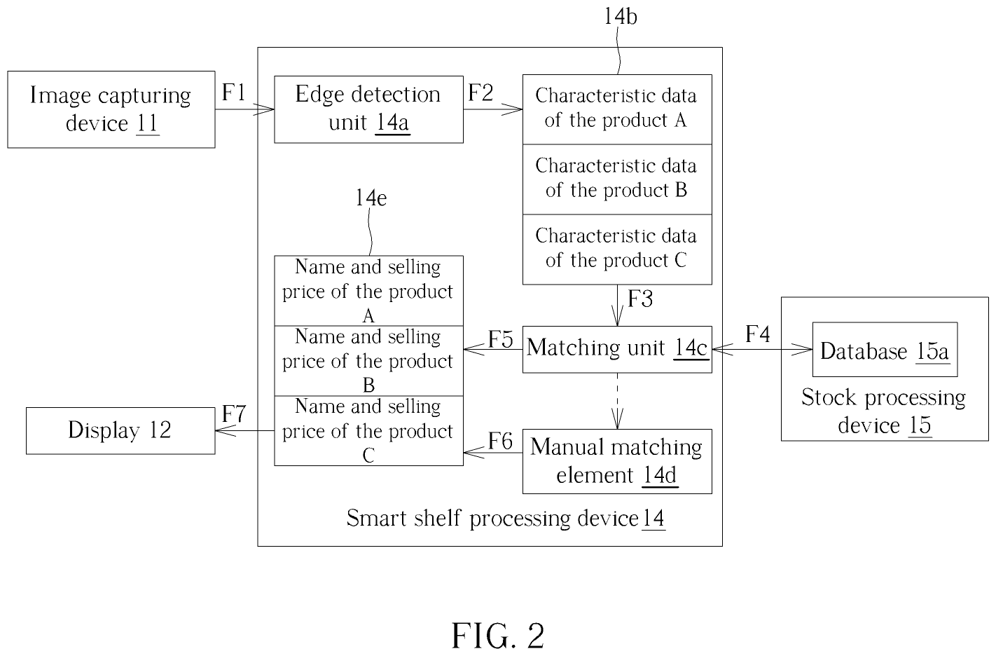

FIG. 2 is an illustration of data flows of the information delivery system 100. First, the image capturing device 11 can acquire the image including the shelf laminate 10 and the plurality of products A to C placed on the shelf laminate 10. Then, the image capturing device 11 can transmit the image to an edge detection unit 14a in the smart shelf processing device 14 through a data flow F1. The edge detection unit 14a can be an image processing function executed by a hardware circuit or a software program. Further, as shown in FIG. 1, the display 12 can display an identification code 16. The identification code 16 can be a quick response code (QR code), but is not limited thereto. The identification code 16 can include identifier information (ID) of the shelf laminate 10, identification information of a store selling the products A to C, and/or a unique shelf code of the shelf laminate 10. Therefore, after the image capturing device 11 acquires the image, the identification code 16 can be detected from the image. The smart shelf processing device 14 can identify the identification code 16 of the display 12 for acquiring a resolution and a displayed width supported by the display 12 according to the image. Further, the smart shelf processing device 14 can acquire characteristic data of the corresponding product by using the edge detection unit 14a according to the image. The characteristic data can be saved to the memory 14b through a data flow F2. The characteristic data of the corresponding product can include the allocated widths and the allocated positions of the corresponding products. Further, the smart shelf processing device 14 can generate the plurality of templates according to the allocated widths and the allocated positions of the corresponding products, and according to the resolution and the displayed width supported by the display 12. Further, the plurality of templates can include multimedia contents previously edited. Then, the characteristic data can be transmitted to a matching unit 14c through a data flow F3. The matching unit 14c can be used for accessing data saved in a database 15a of the stock processing device 15 according to characteristic information of the products A to C. In other words, the image capturing device 11 can transmit the image to the smart shelf processing device 14 for identifying characteristic information of the plurality of products A to C. Then, the smart shelf processing device 14 can control the matching unit 14c for matching the characteristic information of the plurality of products A to C with product information saved in the database 15a of the stock processing device 15 according to the characteristic information of the plurality of products A to C and the database 15a of the stock processing device 15 through a data flow F4. The matching unit 14c can be a data processing function executed by a hardware circuit or a software program. After the plurality of products A to C are successfully identified by the matching unit 14c, the smart shelf processing device 14 acquires the at least one selling message of each product of the plurality of products A to C for displaying the at least one selling message on the display region of the template by the display 12. Here, as previously mentioned, the at least one selling message can include a product name message and/or a product price message. However, when the plurality of products A to C are unidentified by the matching unit 14c, the smart shelf processing device 14 is used for manually configuring the at least one selling message of each product of the plurality of products A to C according to the characteristic information of the plurality of products A to C and the product information saved in the database 15a of the stock processing device 15. In other words, the smart shelf processing device 14 can use the matching unit 14c for automatically acquiring the at least one selling message of each product. Then, the at least one selling message outputted from the matching unit 14c can be saved in the memory 14e through a data flow F5. The smart shelf processing device 14 can also use a manual matching element 14d for manually configuring the at least one selling message for each product. Similarly, the at least one selling message outputted from the manual matching element 14d can be saved in the memory 14e through a data flow F6. The smart shelf processing device 14 can integrate the at least one selling message of each product for posting the at least one selling message to the template displayed by the display 12. Therefore, after the display 12 receives the at least one selling message through a data flow F7, the at least one selling message of each product (i.e., such as a product name and/or a product price message) can be displayed in real-time.

As previously mentioned, the sensors 13 can periodically detect an amount of the plurality of products A to C placed on the shelf laminate 10 for periodically updating the sales status of the plurality of products A to C. Thus, after the sales status of the plurality of products A to C is updated, the smart shelf processing device 14 can select a template from the plurality of templates previously edited for updating the at least one selling message currently displayed on the display 12. For example, if the sensors 13 detect that at least one product is picked up during a period of time, the display 12 can display a pre-edited template corresponding to “popular” products. Then, the smart shelf processing device 14 can notify the stock processing device 15 for determining if a product replenishment process is required. Conversely, if the sensors 13 detect that no product is picked up during a period of time, it implies that the amount of the products A to C are fixed. In the information delivery system 100, the smart shelf processing device 14 can transmit the sales status of the plurality of products A to C to the stock processing device 15. Further, record data (i.e., such as a log file) of the sales status of the plurality of products A to C can be saved to the database 15a. Then, a log-in process can be operated by an inventory manager through a management interface. The inventory manager can use the management interface for checking the sales status and the log file of the plurality of products A to C through the stock processing device 15 and the smart shelf processing device 14. Then, the inventory manager can determine a marketing strategy accordingly. For example, when the inventory manager uses the management interface for checking the sales status and then realizes some products are not selling well, the inventory manager can reset a discount strategy of these products or make a request to the service staff for adjusting placements of these products. For example, when the inventory manager uses the management interface for checking the sales status and then realizes some products are sold out, the inventory manager can determine if the product replenishment process is required. In other words, since the information delivery system 100 can acquire information of the amount of the products and the positions of the products in real-time, the sales strategy and sales management of the products can be optimized by merchants.

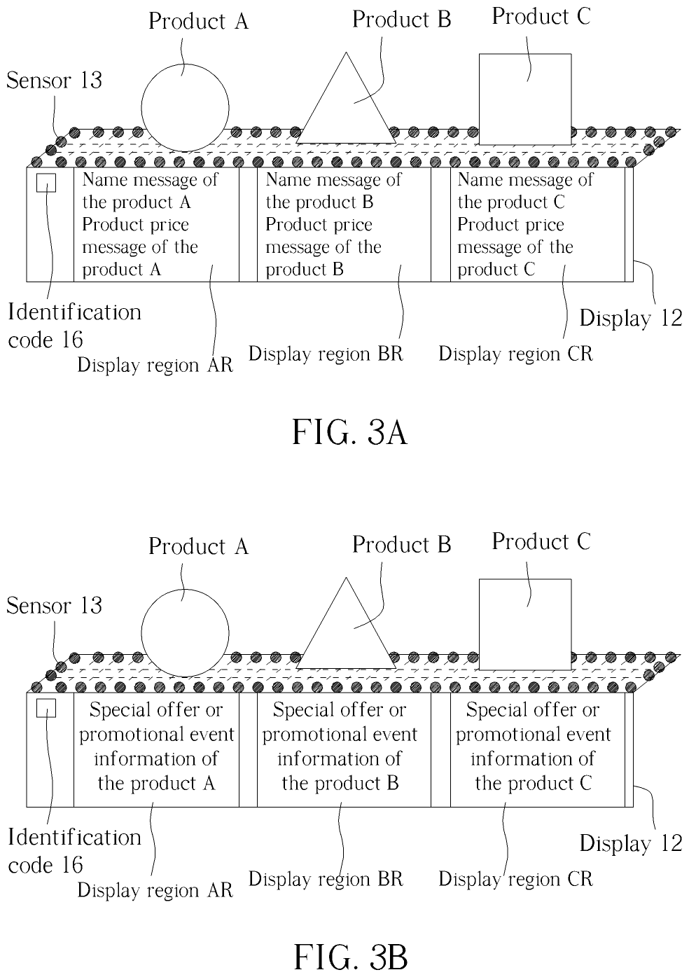

FIG. 3A is an illustration of displaying first multimedia contents by a display of the information delivery system 100. FIG. 3B is an illustration of displaying second multimedia contents by the display of the information delivery system 100. FIG. 3C is an illustration of displaying third multimedia contents by the display of the information delivery system 100. As previously mentioned, the information delivery system 100 can generate the template for displaying on the display 12 placed on the shelf laminate 10 according to image information of the plurality of products A to C. Further, multimedia contents of the generated template can include at least one product name message and/or at least one product price message. As shown in FIG. 3A, a name message and a product price message of the product A can be displayed on a display region AR. A name message and a product price message of the product B can be displayed on a display region BR. A name message and a product price message of the product C can be displayed on a display region CR. Further, multimedia contents of the template displayed on the display 12 can include special offer or promotional event information, as shown in FIG. 3B. Special offer or promotional event information of the product A can be displayed on a display region AR. Special offer or promotional event information of the product B can be displayed on a display region BR. Special offer or promotional event information of the product C can be displayed on a display region CR. Further, multimedia contents of the template displayed on the display 12 can include advertising information, as shown in FIG. 3C. The advertising information of the products A to C can be displayed on a full-screen region FR. Further, the first multimedia contents in FIG. 3A, the second multimedia contents in FIG. 3B, and the third multimedia contents in FIG. 3C can be displayed during different time intervals. For example, the multimedia contents of the template displayed on the display 12 can include the at least one selling message of each product (as shown in FIG. 3A) during a first time interval. Then, multimedia contents of the template displayed on the display 12 can include the promotional events information (as shown in FIG. 3B) or the advertising information (as shown in FIG. 3C) during a second time interval. Further, a time length of the first time interval can be greater than a time length of the second time interval. However, display priorities and display durations of the first multimedia contents, the second multimedia contents, and the third multimedia contents can be user-defined. In the information delivery system 100, any reasonable modification of the template content displayed on the display 12 falls into the scope of the present invention.

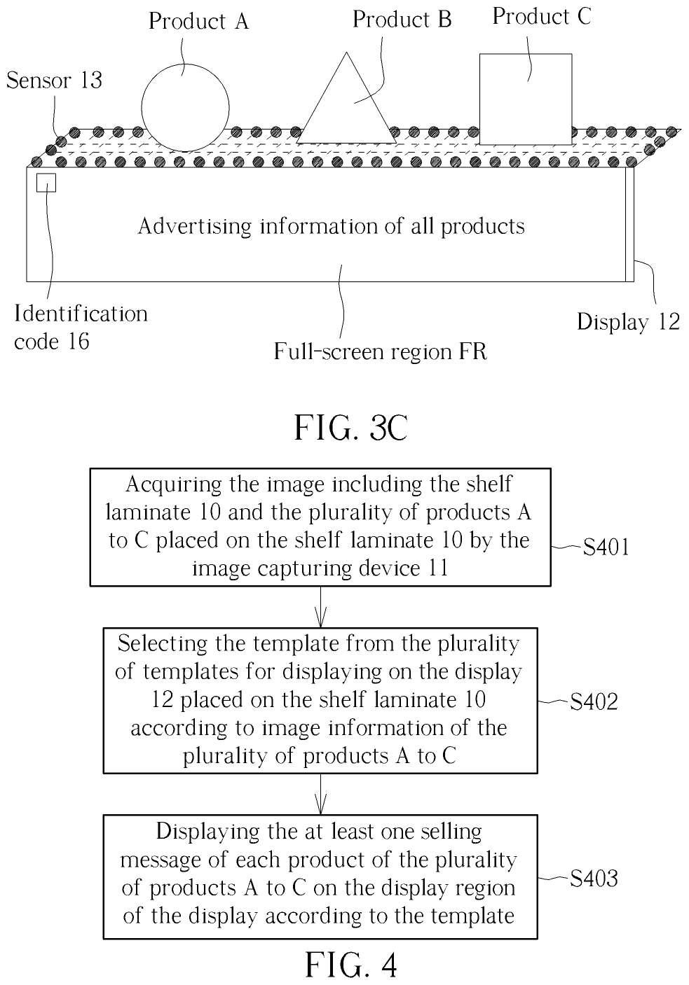

FIG. 4 is a flow chart of performing an information delivery method by the information delivery system 100. The information delivery method can include step S401 to step S403. Any technology modification falls into the scope of the present invention. Step S401 to step S403 are illustrated below.
Step S401: acquiring the image including the shelf laminate 10 and the plurality of products A to C placed on the shelf laminate 10 by the image capturing device 11;
Step S402: selecting the template from the plurality of templates for displaying on the display 12 placed on the shelf laminate 10 according to image information of the plurality of products A to C;
Step S403: displaying the at least one selling message of each product of the plurality of products A to C on the display region of the display according to the template.

Details of the step S401 to step S403 are previously mentioned. Thus, they are omitted here. Since the information delivery system 100 can use the template for displaying selling messages on the display 12 according to the image acquired by the image capturing device 11, a manpower requirement can be reduced. Further, since the information delivery system 100 uses the plurality of sensors 13 for acquiring the sales status (i.e., such as information of the amount of the products and the positions of the products) in real-time, the sales strategy and sales management of the products can be optimized by merchants.

To sum up, the present invention discloses an information delivery method and an information delivery system for applying to a smart shelf system. A purpose of the information delivery method and the information delivery system is to reduce the manpower requirement and increase the user's consumption experience. The information delivery system can automatically generate an appropriate template for displaying selling messages and/or advertising information of the products on the display. Further, the information delivery system uses the plurality of sensors for detecting the sales status of the products in real-time. Therefore, when some products disposed on the shelf laminate are removed or picked up, the selling messages and the template displayed on the display can be synchronously adjusted. When positions of the products are re-allocated, the image capturing device can acquire an updated image. Then, the information delivery system can update the selling messages and the template currently displayed on the display according to the updated image. Further, the inventory manager can manually reset a discount strategy of these products or make the request to the service staff for adjusting the placements of these products. Therefore, sales management and business strategy of the products can be optimized in real-time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information delivery method comprising:
acquiring an image comprising a shelf laminate and a plurality of products placed on the shelf laminate by an image capturing device;
selecting a template from a plurality of templates for displaying on a display placed on the shelf laminate according to image information of the plurality of products; and
displaying at least one selling message of each product of the plurality of products on a display region of the display according to the template;
wherein the template displayed on the display comprises a plurality of display regions, each display region of the plurality of display regions is consistent with an allocated width and an allocated position of a corresponding product.

2. The method of claim 1, further comprising:
identifying an identification code of the display for acquiring a resolution and a displayed width supported by the display according to the image;
acquiring the allocated width and the allocated position of the corresponding product by using an edge detection process according to the image; and
generating the plurality of templates according to the allocated width and the allocated position of the corresponding product, and according to the resolution and the displayed width supported by the display;
wherein the plurality of templates comprises multimedia contents previously edited.

3. The method of claim 2, wherein the identification code comprises identifier information (ID) of the shelf laminate, identification information of a store selling the products, and/or a unique shelf code of the shelf laminate, and after the image capturing device acquires the image, the identification code is detected from the image.

4. The method of claim 2, further comprising:
periodically detecting an amount of the plurality of products placed on the shelf laminate by a plurality of sensors for periodically updating a sales status of the plurality of products; and
selecting a template from the plurality of templates previously edited for updating the at least one selling message currently displayed on the display.

5. The method of claim 1, wherein multimedia contents of the template displayed on the display comprise the at least one selling message of the each product during a first time interval, multimedia contents of the template displayed on the display comprise advertising information during a second time interval, and a time length of the first time interval is greater than a time length of the second time interval.

6. The method of claim 1, further comprising:
transmitting the image to a smart shelf processing device for identifying characteristic information of the plurality of products; and
matching the characteristic information of the plurality of products with product information saved in a database of a stock processing device by the smart shelf processing device according to the characteristic information of the plurality of products and the database of the stock processing device.

7. The method of claim 6, further comprising:
acquiring the at least one selling message of the each product of the plurality of products for displaying the at least one selling message on the display region of the template by the display after the plurality of products are successfully identified;
wherein the at least one selling message comprises a product name message and/or a product price message.

8. The method of claim 6, further comprising:
manually configuring the at least one selling message of the each product of the plurality of products according to the characteristic information of the plurality of products and the product information saved in the database of the stock processing device when the plurality of products are unidentified; and
wherein the at least one selling message comprises a product name message and/or a product price message.

9. The method of claim 6, further comprising:
transmitting a sales status of the plurality of products to the stock processing device through the smart shelf processing device;
saving a log file of the sales status of the plurality of products to the database; and
logging in a management interface by an inventory manager for checking the sales status and the log file of the plurality of products through the stock processing device and the smart shelf processing device, and determining a marketing strategy accordingly.

10. The method of claim 1, further comprising:
detecting a sales status of the plurality of products by a plurality of sensors;
wherein the plurality of sensors are a plurality of optical sensors, and the plurality of optical sensors are placed around an edge of the shelf laminate, or placed along with three-axis of a space of the shelf laminate.

11. An information delivery system comprising:
a shelf laminate configured to place a plurality of products;
an image capturing device configured to acquire an image comprising the shelf laminate and the plurality of products placed on the shelf laminate;
a display adjacent to the shelf laminate and configured to display sales information;
a plurality of sensors placed on the shelf laminate and configured to detect a sales status of the plurality of products; and
a smart shelf processing device coupled to the plurality of sensors, the image capturing device, and the display;
wherein the smart shelf processing device selects a template from a plurality of templates for displaying on the display according to image information of the plurality of products, the display displays at least one selling message of each product of the plurality of products on a display region of the display according to the template, the template displayed on the display comprises a plurality of display regions, each display region of the plurality of display regions is consistent with an allocated width and an allocated position of a corresponding product.

12. The system of claim 11, wherein the smart shelf processing device identifies an identification code of the display for acquiring a resolution and a displayed width supported by the display according to the image, acquires the allocated width and the allocated position of the corresponding product by using an edge detection process according to the image, the smart shelf processing device generates the plurality of templates according to the allocated width and the allocated position of the corresponding product, and according to the resolution and the displayed width supported by the display, and the plurality of templates comprises multimedia contents previously edited.

13. The system of claim 12, wherein the identification code comprises identifier information (ID) of the shelf laminate, identification information of a store selling the products, and/or a unique shelf code of the shelf laminate, and after the image capturing device acquires the image, the identification code is detected from the image.

14. The system of claim 12, wherein the plurality of sensors periodically detect an amount of the plurality of products placed on the shelf laminate for periodically updating the sales status of the plurality of products, and the smart shelf processing device selects a template from the plurality of templates previously edited for updating the at least one selling message currently displayed on the display.

15. The system of claim 11, wherein multimedia contents of the template displayed on the display comprise the at least one selling message of the each product during a first time interval, multimedia contents of the template displayed on the display comprise advertising information during a second time interval, and a time length of the first time interval is greater than a time length of the second time interval.

16. The system of claim 11, wherein the image capturing device transmits the image to the smart shelf processing device for identifying characteristic information of the plurality of products, the smart shelf processing device matches the characteristic information of the plurality of products with product information saved in a database of a stock processing device according to the characteristic information of the plurality of products and the database of the stock processing device.

17. The system of claim 16, wherein the smart shelf processing device acquires the at least one selling message of the each product of the plurality of products for displaying the at least one selling message on the display region of the template by the display after the plurality of products are successfully identified, and the at least one selling message comprises a product name message and/or a product price message.

18. The system of claim 16, wherein the smart shelf processing device is used for manually configuring the at least one selling message of the each product of the plurality of products according to the characteristic information of the plurality of products and the product information saved in the database of the stock processing device when the plurality of products are unidentified, and the at least one selling message comprises a product name message and/or a product price message.

19. The system of claim 16, wherein the smart shelf processing device transmits the sales status of the plurality of products to the stock processing device, a log file of the sales status of the plurality of products is saved to the database, and a log-in process is operated by an inventory manager through a management interface for checking the sales status and the log file of the plurality of products through the stock processing device and the smart shelf processing device, and the inventory manager determines a marketing strategy accordingly.

20. The system of claim 16, wherein the plurality of sensors are a plurality of optical sensors, and the plurality of optical sensors are placed around an edge of the shelf laminate, or placed along with three-axis of a space of the shelf laminate.
